(19) United States
(12) Patent Application Publication
(10) Pub. No.: US 2006/0219838 A1
(43) Pub. Date: Oct. 5, 2006

(54) Attachment means for hang glider simulator

(76) Inventor: Leandre Audet, Lasalle (CA)

Correspondence Address: INVENTARIUM, Suite 1607, 4050 Rosemont Blvd, Montreal, H1X 1M4, CA

(21) Appl. No.: 11/389,727

(22) Filed: Mar. 27, 2006

Related U.S. Application Data
(60) Provisional application No. 60/666,297, filed on Mar. 29, 2005.

(51) Int. Cl. B64C 37/02

(52) U.S. Cl. 244/2

(57) ABSTRACT

An attachment means for hang glider simulator generally comprises a rod, pole or similar oblong means which is articulately attached at both ends to brackets able to rotate along three axes. One such bracket being attached to a vehicle while the other bracket is attached to a seating assembly attached to a hang glider. By moving the vehicle within a range of speed, a student can practice the controls on a real hang glider while maitaining a low safe altitude. Alternatively, a boat or other motorized water vehicle can perform a similar function by having a floater replace the wheel.

This application claims priority based on provisional application 60/666,297 filed Mar. 29, 2005

### BACKGROUND OF THE INVENTION

1. Field of the Invention

This invention relates generally to hang gliders but more particularly to an attachment means to transform a hang glider into a flight simulator tool to train future users of hang gliders.

2. Background

The prior art reveals different types of hang gliders simulators which generally involve elaborate video and computer interfaces. Besides these complex devices, the only other method for teaching hang gliding is to fly in tandem, where the instructor flies along with the student. Beyond that, only basic, static on the ground instructions can prepare for a first solo free flight to teach a novice how to fly.

There is therefore a need for a practical, safe and economical system for teaching hang gliding.

### SUMMARY OF THE INVENTION

In view of the foregoing disadvantages inherent in the known devices now present in the prior art, the present invention, which will be described subsequently in greater detail, is to provide objects and advantages which are:

To provide for a simple hang glider attachment means to attach a hang glider to a moving vehicle so as to turn it into a simulator for teaching hang gliding.

To provide for an attachment means for hang glider which can train a user in a safe environment.

To attain these ends, the present invention generally comprises a rod, pole or similar oblong means which is articulately attached at both ends to brackets able to rotate along three axes. One such bracket being attached to a vehicle while the other bracket is attached to a seating assembly attached to a hang glider. By moving the vehicle within a range of speed, a student can practice the controls on a real hang glider while maitaining a low safe altitude. Alternatively, a boat or other motorized water vehicle can perform a similar function by having a floater replace the wheel. The latter system having the advantage of providing a vast level area that is also softer to crash into should an accident happen. In some embodiment, the rod or pole can be replaced by a cable to provide extra distance between the towing vehicle and the hang glider. This can be practical for example when a boat is the towing vehicle. Also, when on water or snow or ice, a wheel can be replaced by a gliding platform such as a snowboard, wakeboard all such measn referred generally as floating means including but not limited to surfboard and such.

Still, in other embodiments, the seat can be replaced by a harness as is known in the art with a pair of wheels attached to the bar as is also known in the art. In such a configuration, the bracket is attached to the bar by way of a clamping means or any such mechanical equivalent.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE PREFERRED EMBODIMENT

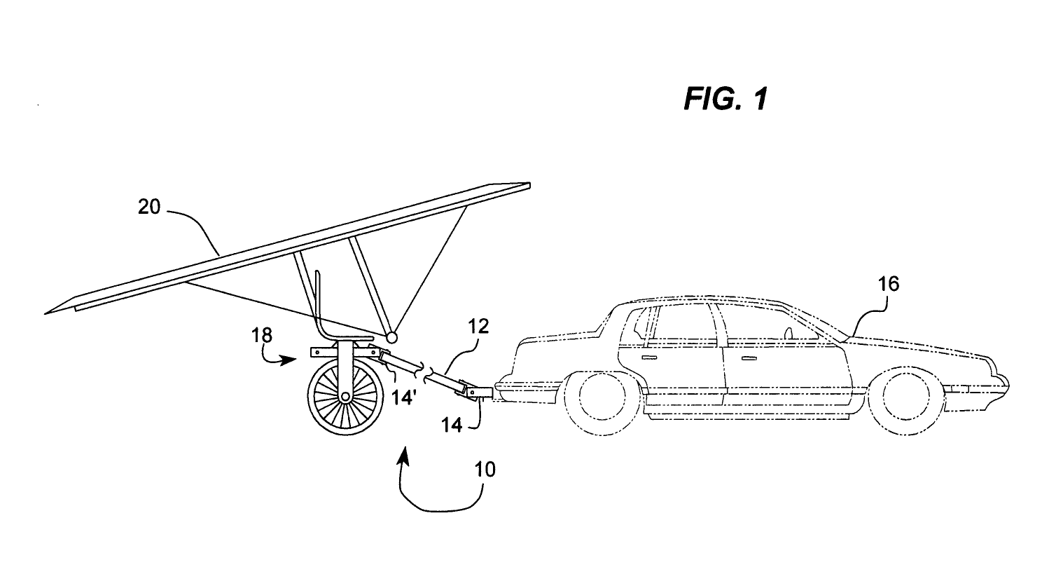

FIG. 1 Side view of the attachment for hang glider with a wheel support for ground use, attached to the rear of a vehicle.

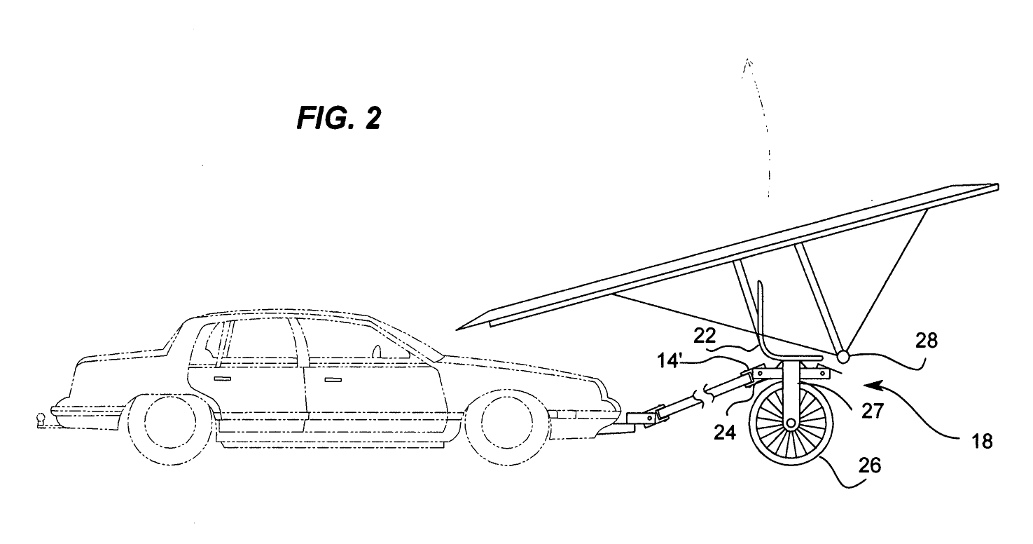

FIG. 2 Side view of the attachment for hang glider with a wheel support for ground use, attached to the front of a vehicle.

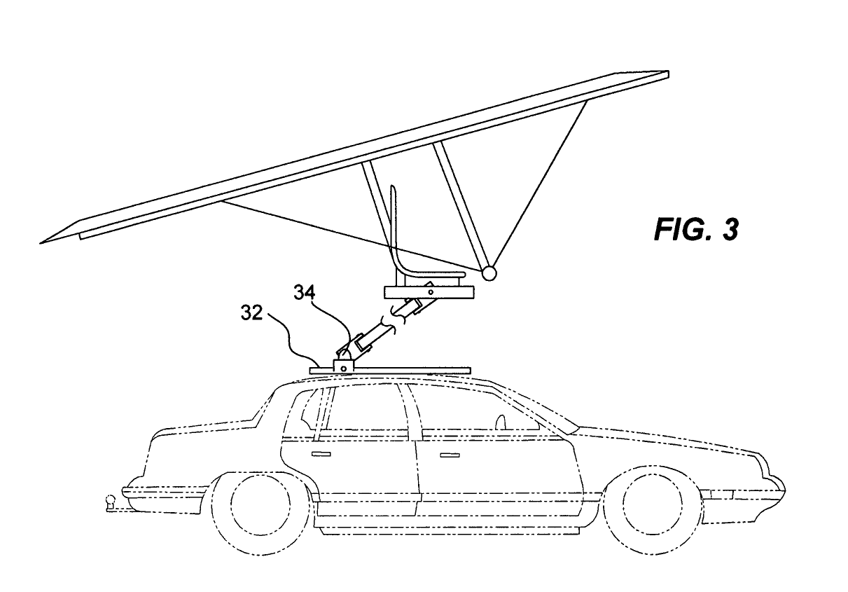

FIG. 3 Side view of the attachment for hang glider without a wheel support, attached to the top of a vehicle.

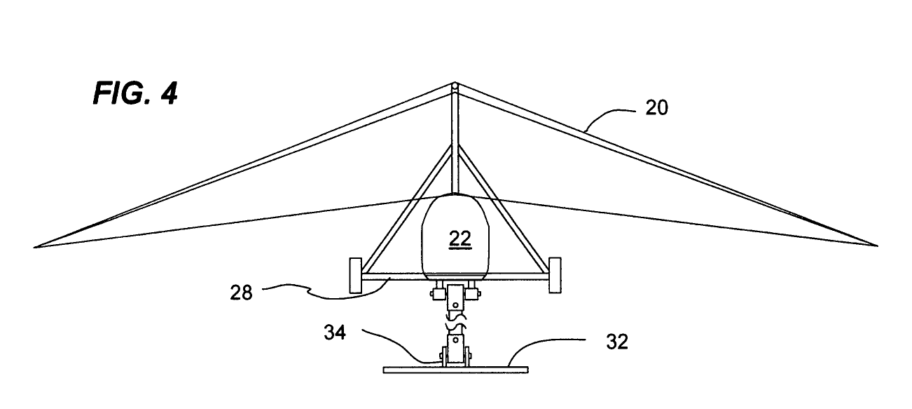

FIG. 4 Front view of attachment for hang glider without a wheel support, attached to the top of a vehicle.

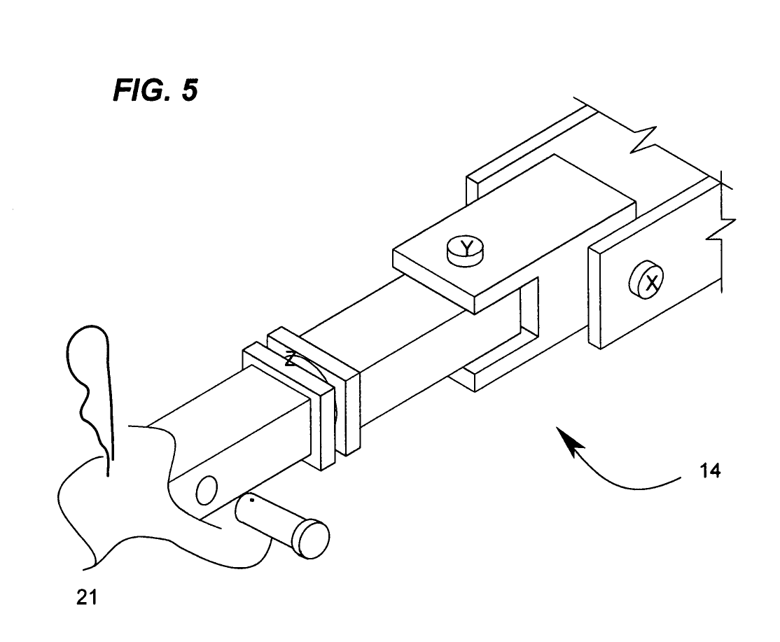

FIG. 5 Isometric view of a bracket.

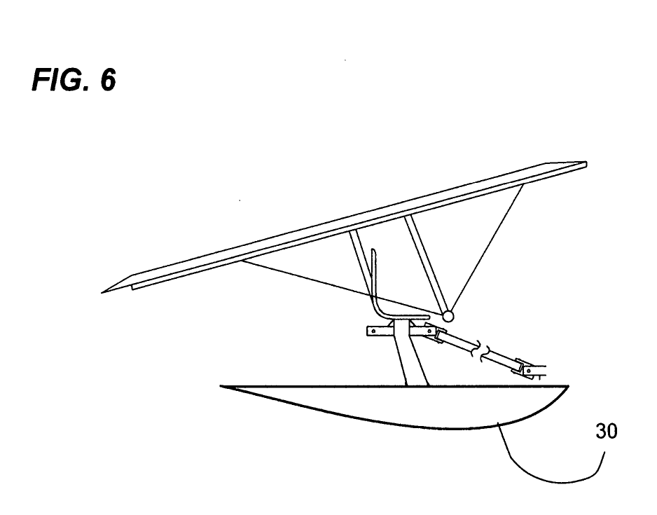

FIG. 6 Side view of attachment for hang glider with a floater for water surface use.

### DETAILED DESCRIPTION OF THE PREFERRED EMBODIMENT

An attachment for hang glider (10) generally comprises at least one pole (12) or similar oblong means which is releasably attached at both ends to brackets (14, 14′) configured to rotate along three axes (X, Y, Z). One such bracket (14) being releasably attached to a towing vehicle (16) while the other bracket (14′) is releasably attached to a hang glider (20). The attachment to the hang glider (20) can be by way of a seating assembly (18), itself being releasably attached to the hang glider (20) so as to easily convert the hang glider (20) back to a regular hang glider (20). In such a manner, standard attachment means are used for releasable attachment means so no further details will be given.

The bracket (14) has an end which is configured to have a connector releasably attached to it. One such connector could be to a hitch configured to mate with a towing ball as is known in hte art. A pin and clip means (21) could be a practical and simple releasable attachment means by which many connectors could be releasably attached. Of course there can be many other types of releasable attachment means taht could perform a similar function.

Also, more than one pole (12) can be used so as to increase the distance between the hang glider (20) and the towing vehicle (16). Pin and clip means (21) can also advantageously be used to extend the length since it would allow for quick addition or reduction of the number of poles (12).

The seating assembly (18) is comprised of a seat (22) and a frame (24) which has the seat (22) attached to it as well as at least one wheel (26) rotationally attached to a fork (27) which is itself releasably attached to the frame (24). How the seat (22) and the wheel (26) are connected to the frame (24) is fairly evident and will not be further discussed. The frame (24) also has the bracket (14′) attached to it in a manner that can be similar to the hitch ball means used on the towing vehicle (16) or by using the pin and clip means (21) described earlier. Using pin and clip means (21) allows a user to change easily the interface between parts, for example.

If a harness (not shown) is used instead of a seat (22), the seating assembly (18) is not required and the bracket (14′) can be releasably connected directly to the control bar (28) of the hang glider (20) using a clamping means (34) (shown in FIG. 3) releasably attached to the bracket (14′) by way of the pin and clip means (21) or other such means.

Alternatively, a boat or other motorized water vehicle (not shown) can be used as a towing vehicle (16) when a floating means (30) replaces the wheel (26) as per FIG. 6.

A standard roof rack (32) can be used to attach the bracket (14) to one of the roof racks's cross bar by way of a clamping means (34) (shown in FIG. 3).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An attachment for hang glider comprising:
a pole releasably attached at both ends to brackets;
said brackets configured for rotating along three axes;
one said bracket being releasably attached to a towing vehicle while said other bracket being releasably attached to a hang glider.

2. An attachment for hang glider as in claim 1 wherein:
said bracket having an end which has a fitting for attachment to a connector.

3. An attachment for hang glider as in claim 1 wherein:
said bracket being connected to a control bar of a said hang glider.

4. An attachment for hang glider as in claim 1 wherein:
said bracket being connected to a seating assembly releasably attached to said hang glider.

5. An attachment for hang glider as in claim 4 wherein:
said seating assembly comprised of a seat and a frame;
said frame having said seat releasably attached to it;
said frame having at least one wheel rotationally attached to a fork;
said fork being releasably attached to said frame.

6. An attachment for hang glider as in claim 3 wherein:
said bracket being connected to said control bar using a clamping means
said clamping means being releasably attached to said bracket.

7. An attachment for hang glider as in claim 4 wherein:
said seating assembly comprised of a seat and a frame;
said frame having said seat releasably attached to it;
said frame having a floating means is releasably attached to said frame.
